(19) United States
(12) Patent Application Publication
(10) Pub. No.: US 2022/0335491 A1
(43) Pub. Date: Oct. 20, 2022

(54) METHOD AND SYSTEM FOR PROVIDING ELECTRONIC COMMERCE SERVICE USING PARTNERSHIP SERVICE CART REALIZED BY API IN SHOPPING MALL

(71) Applicant: BRINGKO CO., LTD., Daegu (KR)

(72) Inventor: Juhyun YOON, Daegu (KR)

(21) Appl. No.: 17/696,363

(22) Filed: Mar. 16, 2022

(30) Foreign Application Priority Data
Apr. 14, 2021 (KR) 10-2021-0048621

(51) Int. Cl. G06Q 30/06; G06Q 20/12

(52) U.S. Cl. CPC G06Q 30/0605; G06Q 30/0633; G06Q 20/12

(57) ABSTRACT

Provided is a method of providing electronic commerce service using a partnership service cart included in a shopping mall by a shopping mall server that is connected to a purchaser terminal through a wired/wireless network and provides a product cart, the method including: acquiring an application programming interface (API) for realizing the partnership service cart on a shopping mall page; outputting the partnership service cart realized by the API to the shopping mall page independently of the product cart; receiving payment completion information in response to a payment request for a product put into the partnership service cart; and transmitting a delivery request for the product included in the payment request upon receiving the payment completion information.

### CROSS-REFERENCE TO RELATED APPLICATION

This application claims priority to and the benefit of Korean Patent Application No. 10-2021-0048621, filed on Apr. 14, 2021, the disclosure of which is incorporated herein by reference in its entirety.

### BACKGROUND

### 1. Field of the Invention

The present invention relates to a system and method for increasing accessibility to electronic commerce services of purchasers residing locally and abroad.

### 2. Discussion of Related Art

Various online real-time transactions are being made through Internet-based networks. Online shopping malls are online real-time transaction platforms based on the Internet. Among them, an open market is typically a market where anyone may buy and sell products, in contrast to individual online shopping malls operated by individual sellers.

Open market platform service providers attract sellers and purchasers as members to provide virtual spaces for transactions between the sellers and purchasers. There are various open market platform service providers in Korea such as Gmarket, 11st, and Coupang.

Due to the nature of the online markets, of course, domestic residents as well as overseas purchasers may access open markets and purchase their desired products. In this case, overseas purchasers have no choice but to pay an overseas delivery fee because domestic products should be delivered to countries where the purchasers reside. In this case, when purchasing several products from one shopping mall or purchasing different products from different shopping malls, overseas purchasers should pay delivery fees for each product.

Currently, some online shopping malls offer bundled delivery of products they sell, but when vendors selling these products are different or these products do not meet bundled delivery conditions, overseas purchasers should receive each product separately, and thus overseas purchasers should pay the delivery fees for these products separately. In addition, purchasers may place an integrated order through a single shopping cart in the same online shopping mall, but may not place an integrated order in different online shopping malls, and therefore the purchasers should visit each shopping mall individually and place an individual order. In other words, when using heterogeneous online shopping malls, purchasers should order and pay individually at each shopping mall. Therefore, the complexity of such shopping reduces purchase motivation of overseas purchasers.

In addition to the inconvenience of the above-described delivery, there may be inconvenience in subscription when overseas purchasers use online shopping malls. Payment and delivery may not be made unless overseas purchasers are subscribed to shopping malls. Therefore, this problem may be a matter to be resolved first. For example, there may be cases where overseas purchasers intend to use domestic online shopping malls, but may not go through an authentication procedure required to subscribe to the domestic online shopping malls. Overseas purchasers may be defined as purchasers residing abroad. Since overseas purchasers may not have nationality (Korean nationality or nationality and status required to subscribe to online shopping malls of each country), there may be no way of verifying their identity. This is because domestic online shopping malls may require personal identification numbers (for example, public certificates, mobile phone numbers, resident registration numbers, etc.) for subscription (or payment). This may be the case where overseas purchasers are Americans, or Koreans who reside abroad and have only US citizenship.

As another example, even when domestic purchasers residing in Korea use online shopping malls, there may be inconvenience in subscribing. For example, foreigners residing in Korea (for example, foreign workers temporarily staying in Korea) may have difficulty subscribing to domestic online shopping malls. This is because foreigners temporarily residing in Korea do not have personal identification numbers. Domestic purchasers will have less difficulty than overseas purchasers because they have connections in Korea. However, as the number of foreigners residing in Korea increases, this problem will have to be resolved soon.

As another example, there may be difficulties in which overseas or domestic purchasers have to pay for each online shopping mall in each country. For example, when purchasers connected from the United States purchase products from online shopping malls in Korea and China or purchase products from two or more online shopping malls in Korea, the purchasers have to pay for each shopping mall each time. Then, payment should be made for each online shopping mall or in a different way for each online shopping mall in each country, which may cause inconvenience.

As another example, there may be inconvenience in using points or mileage provided by online shopping malls. That is, points may be used without being summed up or integrated. For example, points A provided by online shopping mall A and points B provided by online shopping mall B may not be used in combination with each other and may be used only in each online shopping mall. This is because, when the points A and B may not be summed up and used, the amount of points required to use points may be less than a minimum value, or it is not possible to use expensive services or purchase expensive products.

Accordingly, the inventors of the present invention have researched a method of facilitating subscription, ordering, payment, and delivery by increasing accessibility of overseas purchasers to domestic online shopping malls for a long period of time, and have completed the present invention after going through trial and error.

### SUMMARY OF THE INVENTION

The present invention is directed to providing a shopping mall server that implements a partnership service cart on a shopping mall page through an application programming interface (API) provided by a partnership service server, and when a purchaser makes a purchase request and payment request through the partnership service cart, requests delivery of the requested product to a partnership delivery destination managed by a partnership service server, and a method of operating a shopping mall server.

The present invention is also directed to providing a partnership service server that provides an API to a shopping mall server, enables a shopping mall server to implement a partnership service cart on a shopping mall page through the API, and requests delivery of a product to a purchaser according to delivery conditions of the purchaser when a product is delivered to a partnership delivery destination according to a purchase request and payment request through a partnership service cart of the purchaser, and a method of operating a partnership service server.

The present invention is also directed to providing a system including a shopping mall server and a partnership service server that make delivery (primary delivery) to a partnership delivery destination and delivery (secondary delivery) to a purchaser delivery destination according to delivery conditions for a purchaser connected from abroad through a partnership service cart implemented on a domestic shopping mall page.

According to an aspect of the present invention, there is provided a method of providing electronic commerce service using a partnership service cart included in a shopping mall by a shopping mall server that is connected to a purchaser terminal through a wired/wireless network, the method including: acquiring an API for realizing the partnership service cart on a shopping mall page; outputting the partnership service cart realized by the API to the shopping mall page; receiving a purchase request for a product through the partnership service cart from the purchaser terminal; providing a partnership order list for the product included in the purchase request to the purchaser terminal; receiving a payment request for the product from the purchaser terminal; and transmitting a delivery request for the product included in the payment request when the payment of the product is completed.

The method may further include: confirming access by the purchaser terminal to a shopping mall page; and determining whether the access by the purchaser terminal is made from abroad, in which the outputting of the partnership service cart may include outputting the partnership service cart when the access by the purchaser terminal is made from abroad.

The shopping mall page may be implemented in a first language of a first country and provided to the purchaser terminal, and the purchaser terminal may access the shopping mall page from a country different from the first country.

The shopping mall page may be implemented in a first language of a first country and translated into a second language different from the first language and provided to the purchaser terminal, and the purchaser terminal may access the shopping mall page from a country different from the first country.

The acquiring of the API may include acquiring each API for a plurality of online shopping malls, the outputting of the partnership service cart may include separately outputting the partnership service cart to each of the shopping mall pages of the plurality of online shopping malls, the receiving of the purchase request may include receiving a purchase request for a plurality of products selected from the plurality of online shopping malls, and the providing of the partnership order list may include the partnership order list including the plurality of products.

The receiving of the payment request may include receiving a payment request for some of the plurality of products, and the transmitting of the delivery request may include transmitting a delivery request for some products included in the payment request.

The outputting of the partnership service cart may include not outputting or deactivating the partnership service cart when a product is specified as an import ban item in a country where the access by the purchaser terminal is made, or when a product is specified as an export ban item in the country where the access by the purchaser terminal is made.

According to another aspect of the present invention, there is provided a shopping mall server for providing electronic commerce service using a partnership service cart included in a shopping mall, in which the shopping mall server is connected to a purchaser terminal and a partnership service server through a wired/wireless network to provide the electronic commerce service, the shopping mall server including: a communication unit configured to acquire, from the partnership service server, an API for realizing the partnership service cart on a shopping mall page, receive, from the purchaser terminal, a purchase request for a product through the partnership service cart, transmit a partnership order list for the product included in the purchase request to the purchaser terminal, receive a payment request for the product from the purchaser terminal, and transmit a delivery request for the product included in the payment request when the payment of the product is completed; an output unit configured to output the partnership service cart realized by the API to the shopping mall page; and a partnership order list generation unit configured to generate the partnership order list.

According to still another aspect of the present invention, there is provided a method of providing electronic commerce service using a partnership service server included in a shopping mall, in which the partnership service server is connected to a purchaser terminal through a wired/wireless network to provide the electronic commerce service, the method including: transmitting an API for realizing the partnership service cart on a shopping mall page; when a purchase request for a product through the partnership service cart output to the shopping mall page is generated from the purchaser terminal, confirming whether the product included in the purchase request is delivered to a partnership delivery destination specified by the partnership service server; receiving, from the purchaser terminal, a delivery condition for receiving the product included in the purchase request, the delivery condition including a purchaser delivery destination and a delivery method; and transmitting a delivery request for the product included in the purchase request according to the purchaser delivery destination and the delivery method.

The shopping mall page may be implemented in a first language of a first country and provided to the purchaser terminal, and the purchaser terminal may access the shopping mall page from a country different from the first country.

The shopping mall page may be implemented in a first language of a first country and translated into a second language different from the first language and provided to the purchaser terminal, and the purchaser terminal may access the shopping mall page from a country different from the first country.

The transmitting of the API may include transmitting each API for a plurality of online shopping malls, the confirming of the delivery to the partnership delivery destination may include confirming whether at least one of a plurality of products included in the purchase request is delivered to the partnership delivery destination, and the transmitting of the delivery request may include transmitting a delivery request for at least one of the plurality of products when the delivery to the partnership delivery destination is completed.

The delivery method may include selective delivery in which some of the plurality of products are delivered to the purchaser delivery destination and bundled delivery in which all of the plurality of products are delivered to the purchaser delivery destination at once.

The method may further include receiving subscription information for use of the electronic commerce service from the purchaser terminal, the subscription information including an e-mail address, in which the purchaser terminal may transmit a purchase request through the partnership service cart in the shopping mall page when authenticated through the subscription information from the partnership service server.

According to still yet another aspect of the present invention, there is provided a partnership service server for providing electronic commerce service using a partnership service cart, in which the partnership service server is connected to a purchaser terminal and a partnership service server through a wired/wireless network to provide the electronic commerce service, the partnership service server including: an API management unit configured to manage an API for realizing the partnership service cart on a shopping mall page; a delivery confirmation unit configured to confirm whether a product included in a purchase request is delivered to a partnership delivery destination specified by the partnership service server when the purchase request for the product through the partnership service cart output to the shopping mall page is generated; a delivery request generation unit configured to generate a delivery request for the product included in the purchase request according to the purchaser delivery destination and a delivery method; and a communication unit configured to transmit the API to the shopping mall server, receive a delivery condition for receiving the product included in the purchase request from the purchaser terminal, the delivery condition including the purchaser delivery destination and the delivery method, and transmit the delivery request.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a configuration diagram of a system for providing electronic commerce service using a partnership service cart according to an embodiment;

FIG. 2 is a first exemplary diagram of shopping mall pages displayed on purchaser terminals connected from different countries according to an embodiment;

FIG. 3 is a second exemplary diagram of the shopping mall pages displayed on the purchaser terminals connected from different countries according to the embodiment;

FIG. 4 is a configuration diagram of a purchaser terminal, a shopping mall server, and a partnership service server which each provide electronic commerce service using a partnership service cart according to an embodiment;

FIG. 5 is a flowchart illustrating an operation of a system for providing electronic commerce service using the partnership service cart according to the embodiment;

FIG. 6 is an exemplary diagram of a shopping mall page to which the partnership service cart according to the embodiment is output;

FIG. 7 is a flowchart illustrating subscription and authentication of the electronic commerce service using the partnership service cart according to the embodiment;

FIG. 8 is a flowchart illustrating an operation of the system for providing electronic commerce service using the partnership service cart according to the embodiment when a purchaser uses a plurality of online shopping malls; and

FIG. 9 is a diagram for describing a payment method in electronic commerce service according to an embodiment.

It is noted that the accompanying drawings are illustrated as reference for understanding the technical idea of the present invention, and the scope of the present invention is not limited thereto.

### DETAILED DESCRIPTION OF EXEMPLARY EMBODIMENTS

In describing the present invention, when it is determined that related known functions are obvious to those skilled in the art and thus may unnecessarily obscure the subject matter of the present invention, the detailed description thereof will be omitted.

Terms used in the present specification are used only in order to describe specific embodiments rather than limiting the present invention. Singular forms are intended to include plural forms unless the context clearly indicates otherwise. It will be further understood that the terms “comprise” or “have” used in this specification specify the presence of stated features, steps, operations, components, parts mentioned in this specification, or a combination thereof, but do not preclude the presence or addition of one or more other features, numerals, steps, operations, components, parts, or a combination thereof.

Hereinafter, embodiments of the present invention will be described in detail with reference to the accompanying drawings. In describing embodiments of the present invention with reference to the accompanying drawings, components that are the same as or correspond to each other will be denoted by the same reference numerals, and overlapping description thereof will be omitted.

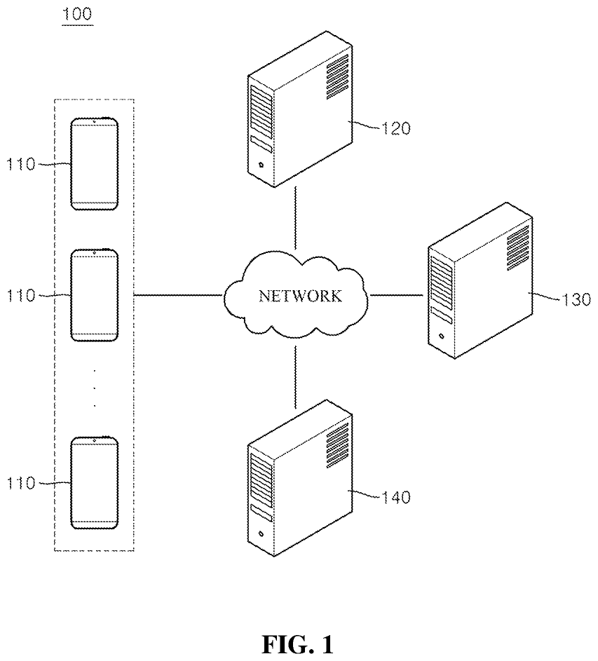

FIG. 1 is a configuration diagram of a system for providing electronic commerce service using a partnership service cart according to an embodiment.

Referring to FIG. 1, a system 100 (hereinafter referred to as a “system”) for providing electronic commerce service using a partnership service cart may include a purchaser terminal 110, a shopping mall server 120, a partnership service server 130, and a payment server 140.

Here, a purchaser who operates the purchaser terminal 110 is an overseas purchaser and may be defined as a purchaser mainly residing abroad. For example, an overseas purchaser may be an American or a Korean who resides abroad but has only US citizenship. In addition, a purchaser who operates the purchaser terminal 110 may be a domestic purchaser. A domestic purchaser may be defined as a purchaser residing in Korea. For example, a domestic purchaser may be a foreigner residing in Korea (for example a foreign worker temporarily residing in Korea).

The purchaser terminal 110 is a terminal that enables an overseas purchaser to use an online shopping mall, and may be any of various devices such as a smart phone, a mobile phone, a tablet personal computer (PC), a desktop, and a laptop, but is not limited thereto.

The purchaser terminal 110 may communicate with the shopping mall server 120, the partnership service server 130, and the payment server 140 through a wired/wireless network. In the wired/wireless network, a network N is a connection structure in which information may be transmitted or received between nodes such as a terminal and a server, and examples of such a network may include the Internet, a local area network (LAN), a wireless local area network (wireless LAN), a wide area network (WAN), a personal area network (PAN), 3G, 4G, 5G, wireless fidelity (Wi-Fi), Bluetooth, near-field communication (NFC), radio frequency identification (RFID), a home network, etc., but are not limited thereto.

The purchaser terminal 110 may perform a subscription procedure to the partnership service server 130 in order to use the electronic commerce service according to an embodiment of the present invention. The purchaser terminal 110 may transmit subscription information to the partnership service server 130. The subscription information is information for identifying a purchaser who operates the purchaser terminal 110, and may mainly include an e-mail address or a social network service (SNS) account. The purchaser may subscribe to the electronic commerce service with only the e-mail address or SNS account. The subscription information may include personal identification information in addition to the e-mail or SNS accounts. The personal identification information may also include arbitrary personal identification information (for example, e-mail) that a purchaser may freely create at its discretion and non-arbitrary personal identification information (for example, a certificate, a mobile phone number, a resident registration number, etc.) that a purchaser may obtain only through a certain statutory or administrative procedure. The arbitrary personal identification information is necessarily included in the subscription information, but the non-arbitrary personal identification information may not necessarily be included.

The purchaser terminal 110 may receive the authentication result from the partnership service server 130. The partnership service server 130 may authenticate or reject the purchaser terminal 110 through the subscription information. For example, the partnership service server 130 may determine whether the e-mail address included in the subscription information is valid (whether it is an e-mail for the purchaser of the purchaser terminal 110) and, if valid, approve the subscription of the purchaser, and if not valid, reject the subscription of the purchaser.

When the subscription through the partnership service server 130 is completed, the purchaser terminal 110 may access an online shopping mall managed by the shopping mall server 120. The purchaser may access the online shopping mall through the purchaser terminal 110 and search for the shopping mall page through a browser or an application provided by the online shopping mall. Here, the subscription through the partnership service server 130 does not necessarily need to be completed before it is possible for the purchase terminal 10 to access an online shopping mall or purchase a product. The subscription may function during access to the online shopping mall or during purchase (for example, while a purchaser views a partnership order list and operates a purchase button)

Meanwhile, the shopping mall server 120 may provide each shopping mall page constituting an online shopping mall to the purchaser terminal 110 while operating the online shopping mall. When the shopping mall page is output through the application of the purchaser terminal 110, a purchaser may start purchasing while viewing the shopping mall page. Here, a subject operating the shopping mall server 120 may include an operator of an open market or an operator of an individual online shopping mall. For example, the shopping mall server 120 may operate domestic open markets such as “Coupang,” “Tmon,” or “WEMAKEPRICE” or an online shopping mall such as “SEOUL BUND.” Hereinafter, the online shopping mall is a virtual space where a purchaser may shop and is interpreted as a general concept including an open market. Hereinafter, “online shopping mall” and “open market” may be used interchangeably.

The shopping mall server 120 may output a partnership service cart together with a shopping mall page by including the partnership service cart in the shopping mall page in order to facilitate the purchase of the purchaser terminal 110. The purchaser terminal 110 may make a purchase request through the partnership service cart to the shopping mall server 120.

For example, the shopping mall server 120 may output a mark (for example, an icon or a link) indicating the partnership service cart to the shopping mall page. A purchaser may select a product from the shopping mall page and put the selected product into the partnership service cart. When the product put into the partnership service cart is paid for by a purchaser, the product may be delivered to the purchaser. In other words, conventionally, when a purchaser selects a product on a shopping mall page, the purchaser may put the product into an individual cart provided by the shopping mall server 120 (operating entity of the online shopping mall). When the product put into the individual cart is paid for by the purchaser, the product may be delivered to the purchaser. However, according to an embodiment, the purchaser may make payment by putting the product in the partnership service cart provided by the partnership service server 130.

Furthermore, when a purchaser intends to purchase products from a plurality of online shopping malls operated by the plurality of shopping mall servers 120, the purchaser may purchase the products through the partnership service cart output from shopping mall pages of each online shopping mall. The purchaser may put a first product into a partnership service cart in a shopping mall page of an online shopping mall operated by a first shopping mall server, put a second product into the same partnership service cart in a shopping mall page of an online shopping mall operated by a second shopping mall server, and pay for both the first and second products through the partnership service cart and receive the paid products.

The shopping mall server 120 may receive or be offered an application programming interface (API) from the partnership service server 130 to implement a partnership service cart on a shopping mall page that the shopping mall server 120 itself operates. Alternatively, the shopping mall server 120 may acquire the API by accessing the API system. The API is a set of several programmed functions, and may be programmed differently for each function to be implemented. Here, the API designed to implement the partnership service cart may be called the partnership service cart API. The partnership service cart API may be combined with an algorithm or the API (online shopping mall API) that implements an online shopping mall. The partnership service cart API may be programmatically combined by the shopping mall server 120 or by an administrator of the shopping mall server 120. When the partnership service cart API is combined with the online shopping mall API, the partnership service cart (or an icon representing the partnership service cart) may be output to the shopping mall page.

The shopping mall server 120 may implement a partnership service cart from the partnership service cart API and output the partnership service cart to the shopping mall page. The purchaser of the purchaser terminal 110 may recognize the output partnership service cart through the five senses.

When a purchase is made (for example, a purchaser puts a product into a partnership service cart and clicks a purchase button), the shopping mall server 120 may receive a purchase request for the product through the partnership service cart from the purchaser terminal 110.

When the shopping mall server 120 receives the purchase request for the product, the shopping mall server 120 may transmit information (for example, a product name, price, quantity, supplier, etc.) on the product included in the purchase request to the partnership service server 130.

The partnership service server 130 may generate a partnership order list for a product included in a purchase request and provide the generated partnership order list to the purchaser terminal 110. Here, the partnership order list may be different from the order list that the shopping mall server 120 itself generates. For example, the partnership order list may be set by the partnership service server 130 or the administrator who operates the partnership service server 130, and may be designed to include other products put into other online shopping malls. A purchaser may confirm products put into a plurality of online shopping malls from the partnership order list.

When a purchaser pays for a product through the partnership order list, the partnership service server 130 may receive a payment request from the purchaser terminal 110. Here, the partnership order list may list and include a plurality of products put into a plurality of shopping mall pages of a plurality of online shopping malls. The purchaser may select some or all of the plurality of products, and the purchaser terminal 110 may transmit a payment request for some or all of the plurality of products.

When the purchaser completes the payment, the shopping mall server 120 may request delivery of the product included in the payment request to the partnership delivery destination. The shopping mall server 120 may operate to transmit a delivery request for a product to a delivery server (not illustrated) or to perform a delivery operation by itself. Here, the partnership order list may list and include a plurality of products put into a plurality of shopping mall pages of a plurality of online shopping malls. When the purchaser selects some or all of the plurality of products and completes payment, the shopping mall server 120 may transmit a delivery request for some or all of the plurality of products or may perform a delivery operation for some or all of the plurality of products.

Here, the partnership delivery destination may be a location where the paid product arrives before finally being delivered to the purchaser. The delivery destination when the product is finally delivered to a purchaser may include an address of the purchaser as the purchaser delivery destination, whereas the partnership delivery destination may be under the management of the partnership service server 130 or may be a location designated directly. According to an embodiment, since the purchaser resides abroad and the online shopping mall is in Korea, it is necessary to primarily gather the purchased products before the purchased products are delivered abroad. After being gathered first, the purchased products may be delivered secondarily across borders. Here, a domestic location where the purchased products are primarily gathered may be a partnership delivery destination.

In addition, the shopping mall server 120 may not output the partnership service cart or may automatically deactivate the output partnership service cart when an import ban item is specified in the country where the access by the purchaser terminal 110 is made. The import ban item may be set manually through the administrator of the shopping mall server 120 or automatically by the API. Alternatively, when at least one product included in the purchase request of the purchaser terminal 110 is specified as an import ban item in the country where the access by the purchaser terminal 110 is made, the partnership service server 130 may reject the payment of the product even when the purchaser terminal 110 makes a payment request. For example, the partnership service server 130 may output a pop-up that rejects payment in response to the payment request.

Meanwhile, the partnership service server 130 may generate and provide the partnership service cart that is output to the shopping mall page of the online shopping mall. The partnership service server 130 may transmit or provide the API to the shopping mall server 120. The partnership service server 130 may store or generate the API.

When a product is purchased through the partnership service cart output to the shopping mall page (when the purchaser terminal 110 transmits a payment request to the partnership service server 130 and completes payment), the partnership service server 130 determines whether the purchased product is delivered to the partnership delivery destination. The partnership service server 130 may receive information on delivery from the partnership delivery destination and confirm the delivery.

The partnership service server 130 may receive a delivery condition for receiving the product included in the purchase request from the purchaser terminal 110. Here, the delivery condition may include a purchaser delivery destination and a delivery method. The purchaser delivery destination may be a delivery destination where a product finally arrives with a purchaser. The delivery method may include selective delivery or bundled delivery. The selective delivery may be understood some of a plurality of paid products being delivered first. When some of the plurality of paid products first arrive at the partnership delivery destination, the arriving products may first be delivered to an overseas purchaser delivery destination. The bundled delivery may be understood as all of the plurality of paid products being delivered at once. After all of the plurality of paid products arrive at the partnership delivery destination, all of the products may be later delivered to the purchaser delivery destination at once.

Meanwhile, the payment server 140 may receive a payment request and perform payment. The payment server 140 may directly receive a payment request from the purchaser terminal 110 or may receive a payment request from the purchaser terminal 110 through the partnership service server 130. Alternatively, the system 100 according to the embodiment may not include the payment server 140. In this case, the payment may be performed by the partnership service server 130.

According to an embodiment of the present invention, the partnership service cart may be implemented on and output to the online shopping mall by linking the API provided by the partnership service server 130 with the API of the online shopping mall operated by the shopping mall server 120. Conventionally, by moving text and an image of a shopping mall page of an online shopping mall (for example, by a sentence analysis method such as parsing), the shopping mall page may be provided to the purchaser terminal 110. However, the conventional method may provide a purchaser with the same effect as purchasing a product from the online shopping mall, but may not involve directly purchasing the product from the online shopping mall. That is, since the conventional method provides a purchaser with the effect of direct online shopping, it is difficult to provide the purchaser with a real-time or immediate response for subscription, payment, and delivery. However, in an API linkage method according to an embodiment, a purchaser directly purchases a product from the online shopping mall, and thus it may highlight advantages of an online shopping mall by providing a purchaser with an immediate response to subscription, payment, and delivery. In addition, the API linkage method may compensate for the disadvantages of the online shopping mall by allowing the purchaser to process the restrictions (complexity of subscription and authentication) of the online shopping mall through the partnership service server 130.

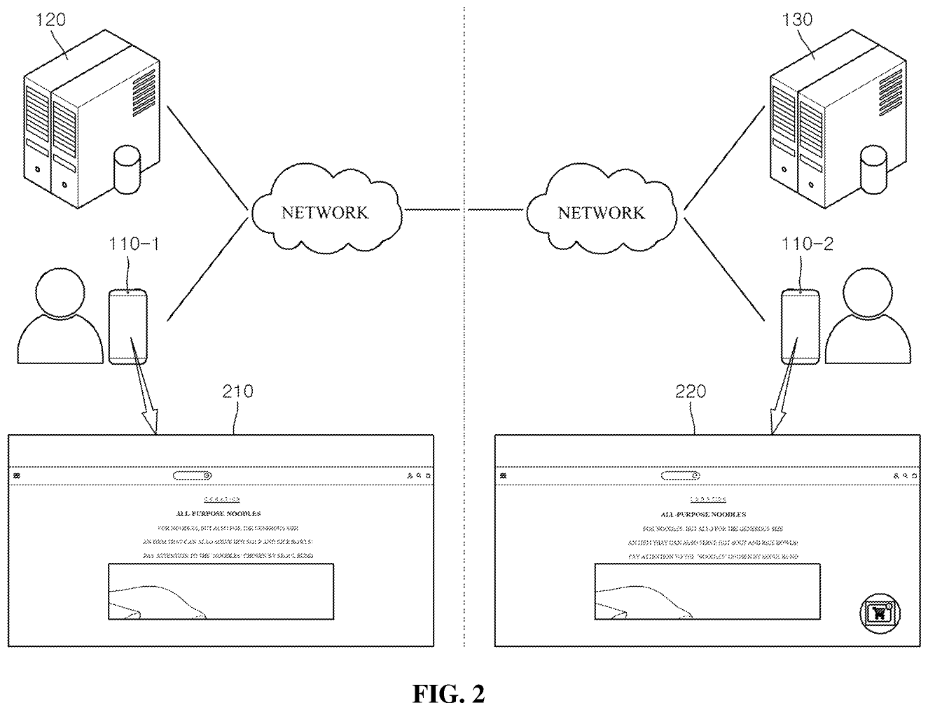

FIG. 2 is a first exemplary diagram of shopping mall pages displayed on purchaser terminals connected from different countries according to an embodiment.

FIG. 2 illustrates a situation in which the system according to the embodiment operates. A shopping mall page displayed according to an access region of a purchaser may have a form of a first example. The shopping mall server 120 operates an online shopping mall in a first country, a first purchaser resides in the first country, and a first purchaser terminal 110-1 may access the online shopping mall in the first country through a network. A second purchaser resides in a second country, and a second purchaser terminal 110-2 may access an online shopping mall in the second country through a network. A first language (for example, Korean) may be used in the first country, and a second language (for example, English) may be used in the second country. Here, it is illustrated that the shopping mall server 120 is in the first country and the partnership service server 130 is located in the second country, but the servers are not limited thereto.

When the first purchaser terminal 110-1 accesses the online shopping mall in the first country, the shopping mall page may be expressed in the first language, and the partnership service cart may not be output to the shopping mall page (see 210 in the drawing).

When the second purchaser terminal 110-2 accesses the online shopping mall in the second country, the shopping mall page may be expressed in the first language, and the partnership service cart may be output to the shopping mall page (see 220 in the drawing). The partnership service cart may be expressed on either side of the shopping mall page in the form of a floating icon, but is not limited in implementation methods such as the location and shape. Here, the shopping mall page may be implemented in the first language without change and not implemented in or translated into the second language, and may include a partnership service cart.

Here, the shopping mall server 120 may determine whether the second purchaser terminal 110-2 accesses the shopping mall page from abroad, and accordingly, may determine whether to output the partnership service cart. The shopping mall server 120 may confirm the access of the second purchaser terminal 110-2 to the shopping mall page and determine whether the access of the second purchaser terminal 110-2 is made from abroad. When it is determined that the access of the second purchaser terminal 110-2 is made from abroad, the shopping mall server 120 may provide a shopping mall page including a partnership service cart to the second purchaser terminal 110-2. When it is determined that the access of the second purchaser terminal 110-2 is not made from abroad (the access of the second purchaser terminal 110-2 is made in Korea), the shopping mall server 120 may provide the conventional shopping mall page not including the partnership service cart to the second purchaser terminal 110-2. The shopping mall server 120 may determine whether an access is made from abroad through a network communication resource (for example, an IP address).

Conventionally, when the second purchaser terminal 110-2 accesses the online shopping mall in the second country, a shopping mall page as indicated by reference number 210 is displayed. However, when the shopping mall server 120 combines the API received from the partnership service server 130, the partnership service cart is output to the shopping mall page, and thus a purchaser may put products into the online shopping mall implemented in the first language through the partnership service cart and pay for the products.

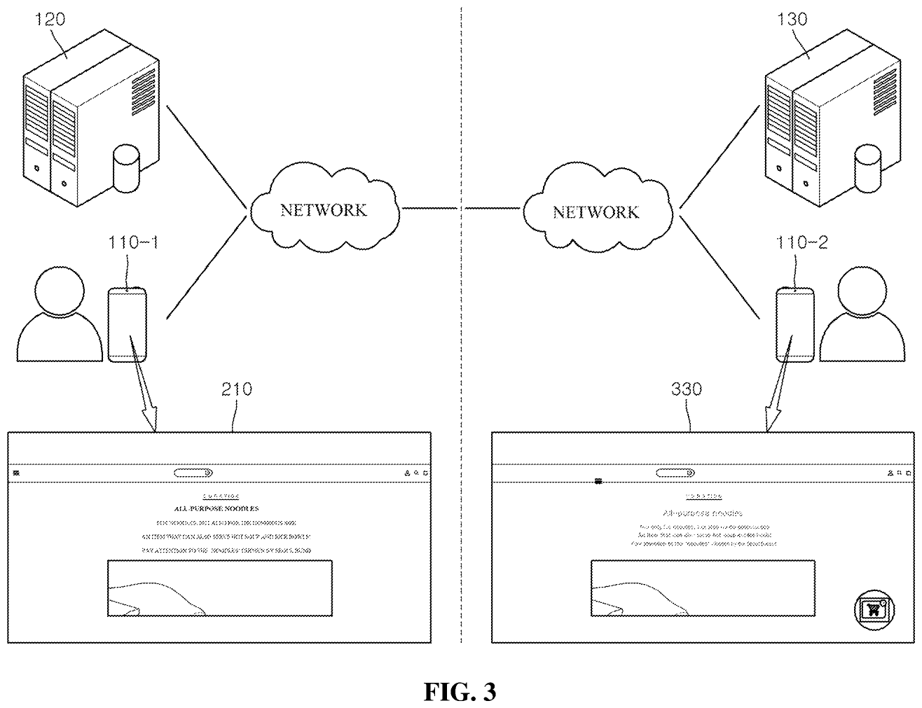

FIG. 3 is a second exemplary diagram of the shopping mall pages displayed on the purchaser terminals connected from different countries according to the embodiment.

Referring to FIG. 3, a situation in which the system according to the embodiment operates may be illustrated in the same manner as in FIG. 2. However, a shopping mall page displayed according to an access region of a purchaser may have a form of a second example.

When the first purchaser terminal 110-1 accesses the online shopping mall in the first country, the shopping mall page may be expressed in the first language, and the partnership service cart may not be output to the shopping mall page (see 210 in the drawing).

When the second purchaser terminal 110-2 accesses the online shopping mall in the second country, the shopping mall page may be expressed in the second language, and the partnership service cart may be output to the shopping mall page (see 330 in the drawing). The partnership service cart may be expressed on either side of the shopping mall page in the form of the floating icon, but is not limited in implementation methods such as the location and shape. Here, the shopping mall page may be implemented in the first language without change and translated into the second language, and may include a partnership service cart. For example, a shopping mall page may be automatically translated by an application (web-browser) that helps a purchaser navigate a shopping mall page. The application may classify regions through an IP address of the second purchaser terminal 110-2, and then translate and output the shopping mall page, which is implemented in the first language instead of the second language, into the second language.

Alternatively, the shopping mall page may be directly implemented in the second language. The API provided by the partnership service server 130 may set the shopping mall page in the second language, and output the shopping mall page in the second language together with the partnership service cart when the second purchaser terminal 110-2 accesses the shopping mall page from the second country.

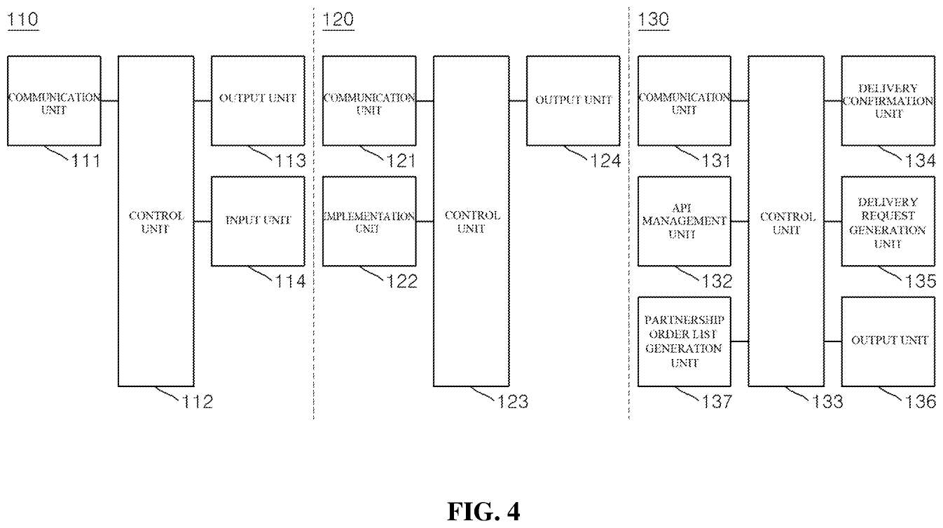

FIG. 4 is a configuration diagram of a purchaser terminal, a shopping mall server, and a partnership service server which each provide electronic commerce service using a partnership service cart according to an embodiment.

Referring to FIG. 4, a system according to an embodiment may include a purchaser terminal 110, a shopping mall server 120, and a partnership service server 130.

The purchaser terminal 110 may include a communication unit 111, a control unit 112, an output unit 113, and an input unit 114. The control unit 112 may control the communication unit 111, the output unit 113, and the input unit 114.

The communication unit 111 may transmit or receive information or data to or from the shopping mall server 120 and the partnership service server 130 through a network.

The control unit 112 may transmit a subscription request to the partnership service server 130 through the communication unit 111 and receive a subscription result (authentication result). In addition, the control unit 112 may transmit a purchase request to the shopping mall server 120 through the communication unit 111, and may transmit a payment request and delivery conditions to the partnership service server 130.

The output unit 113 may output information or data such as a shopping mall page to a purchaser. The purchaser may recognize matters related to subscription, purchase, payment, and delivery through the output unit 113.

The input unit 114 may receive an operation for the purchaser terminal 110 from the purchaser. For example, the input unit 114 may receive a touch of a purchaser through a touch screen.

In addition, the shopping mall server 120 may include a communication unit 121, an implementation unit 122, a control unit 123, and an output unit 124. The control unit 123 may control the communication unit 121, the implementation unit 122, and the output unit 124.

The communication unit 121 may transmit or receive information or data to or from the purchaser terminal 110 and the partnership service server 130 through a network.

The control unit 123 may receive a purchase request from the purchaser terminal 110 through the communication unit 121. Specifically, the communication unit 121 may receive an API for implementing a partnership service cart on a shopping mall page from the partnership service server 130, receive a purchase request for a product through the partnership service cart from the purchaser terminal 110, and transmit a delivery request for the product included in the payment request to the partnership delivery destination when the payment of the product is completed.

The implementation unit 122 may implement a partnership service cart from the API received from the partnership service server 130. The implementation unit 122 may link and combine the API with the online shopping mall API.

The output unit 124 may output information or data on an operation status of an online shopping mall to an administrator of the shopping mall server 120. The administrator of the shopping mall server 120 may recognize matters related to subscription, purchase, payment, and delivery for the online shopping mall through the output unit 124.

The partnership service server 130 may include a communication unit 131, an API management unit 132, a control unit 133, a delivery confirmation unit 134, a delivery request generation unit 135, an output unit 136, and a partnership order list generation unit 137. The control unit 133 may control the communication unit 131, the API management unit 132, the delivery confirmation unit 134, the delivery request generation unit 135, the output unit 136, and the partnership order list generation unit 137. The communication unit 131 may transmit or receive information or data to or from the purchaser terminal 110 and the shopping mall server 120 through a network.

The control unit 133 may transmit or provide the API to the shopping mall server 120 through the communication unit 131, receive delivery conditions (the delivery conditions include a purchaser delivery destination and a delivery method) for receiving the product included in the purchase request, and transmit a delivery request to the purchaser delivery destination.

The API management unit 132 may store and generate the API for implementing the partnership service cart on the shopping mall page. The API handled by the API management unit 132 may include a partnership service cart API and a partnership order list API.

When a purchase request for a product through the partnership service cart output to the shopping mall page is generated from the purchaser terminal 110, the delivery confirmation unit 134 may confirm whether the product included in the purchase request is delivered to the partnership delivery destination specified by the partnership service server 130. Alternatively, the delivery confirmation unit 134 may confirm whether some or all of the products included in the payment request received from the purchaser terminal 110 or the payment completion information corresponding to the payment request have been delivered to the partnership delivery destination specified by the partnership service server 130. The delivery confirmation unit 134 may confirm whether the delivery is completed through the information received from the partnership delivery destination.

Here, when the control unit 133 receives a payment request from the purchaser terminal 110, the control unit 133 may perform the payment by itself or request the payment server (not illustrated) to perform the payment. When the payment is completed, the control unit 133 may transmit payment completion information to the shopping mall server 120. When the payment is not completed, the control unit 133 may wait until the payment is completed.

The delivery request generation unit 135 may generate a delivery request for the product included in the purchase request (or payment request or payment completion information) according to the delivery conditions, that is, the purchaser delivery destination and the delivery method. The delivery request generation unit 135 may generate a delivery request including the purchaser delivery destination (address of a foreign country where a purchaser resides) and the delivery method (selection of selective delivery or bundled delivery and selection of delivery means) received from the purchaser terminal 110.

The output unit 136 may output information or data on subscription, purchase, payment, and delivery of the electronic commerce service according to the embodiment to the administrator of the partnership service server 130.

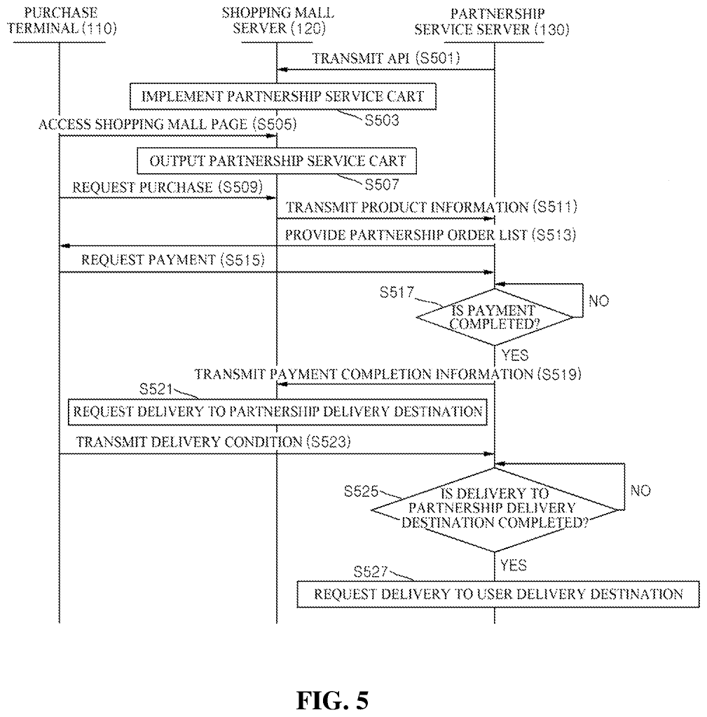

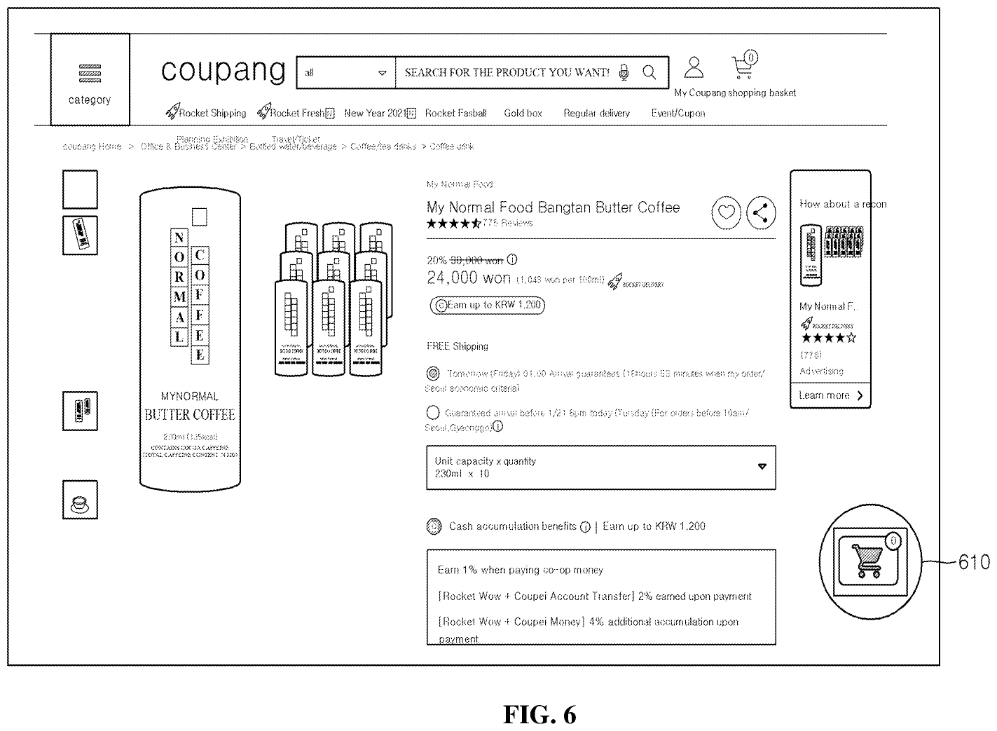

FIG. 5 is a flowchart illustrating an operation of a system for providing electronic commerce service using a partnership service cart according to an embodiment, and FIG. 6 is an exemplary diagram of a shopping mall page to which the partnership service cart according to an embodiment is output.

Referring to FIG. 5, operations of a system for providing electronic commerce service using a partnership service cart are illustrated.

The partnership service server 130 may transmit the API to the shopping mall server 120, and the shopping mall server 120 may acquire the API (operation S501).

The shopping mall server 120 may implement the partnership service cart from the API (operation S503). The partnership service cart API included in the API may be combined with the API of the online shopping mall. This combination may be performed by the shopping mall server 120 or the administrator of the shopping mall server 120.

The purchaser terminal 110 may access the shopping mall page (operation S505). Preferably, the purchaser terminal 110 may access, from abroad, a shopping mall page of an online shopping mall operated in Korea.

When the purchaser terminal 110 accesses the shopping mall page, the shopping mall server 120 may output the implemented partnership service cart to the shopping mall page (operation S507). For example, when the partnership service cart API is combined with the online shopping mall API, the shopping mall server 120 may be displayed in one area of the shopping mall page. Referring to FIG. 6, an icon 610 indicating a partnership service cart may be displayed on any one shopping mall page of the online shopping mall. The partnership service cart icon 610 is also floating on the shopping mall page, but may be replaced with a button-type user interface (UI) that accepts an input operation of a purchaser. At the same time, the shopping mall page is originally implemented in Korean, but may be displayed after being translated into English by an Internet browser. The purchaser may request a purchase (including a product) and request payment on the shopping mall page of the present example. This partnership service cart is mainly output when the purchaser terminal 110 accesses the shopping mall page from abroad, but is not limited thereto. Even when the purchaser terminal 110 accesses the shopping mall page in Korea, when the purchaser may not directly subscribe to the online shopping mall, the shopping mall page of the present example may be displayed.

Returning back to FIG. 5, when the purchaser puts a product into the partnership service cart on the online shopping mall and operates a purchase button, the purchaser terminal 110 may transmit a purchase request to the shopping mall server 120 (operation S509).

When the shopping mall server 120 receives the purchase request for the product, the shopping mall server 120 may transmit information (for example, a product name, price, quantity, supplier, etc.) on the product included in the purchase request to the partnership service server 130 (operation S511).

The partnership service server 130 may generate a partnership order list and transmit and provide the generated partnership order list to the purchaser terminal 110 (operation S513).

When a purchaser confirms that the product included in the partnership order list is selected by the purchaser and operates the payment button, the purchaser terminal 110 may transmit a payment request to the partnership service server 130 (operation S515). The partnership service server 130 may perform the payment and determine whether the payment is completed (operation S517). When the payment is completed, the partnership service server 130 may transmit the payment completion information to the shopping mall server 120 (YES in operation S517 and operation S519). When the partnership service server 130 does not complete the payment, the partnership service server 130 may maintain the payment processing (NO in operation S517).

When the shopping mall server 120 receives the payment completion information, the shopping mall server 120 may request delivery of the paid product to the partnership delivery destination (operation S521). The shopping mall server 120 may request delivery from a delivery server (not illustrated) or a seller of a product.

At the same time, the purchaser terminal 110 may transmit the delivery conditions to the partnership service server 130 (operation S523). The delivery conditions may include the purchaser delivery destination and the delivery method.

The partnership service server 130 may confirm whether the delivery of the paid product to the partnership delivery destination is completed (operation S525). When the delivery to the partnership delivery destination is not completed, the partnership service server 130 may wait until the delivery to the partnership delivery destination is completed (NO in operation S525).

When the delivery to the partnership delivery destination is completed, the partnership service server 130 may request the delivery to the user delivery destination (YES in operation S525 and operation S527). The partnership service server 130 may request delivery from a delivery server (not illustrated) or may directly perform a delivery operation.

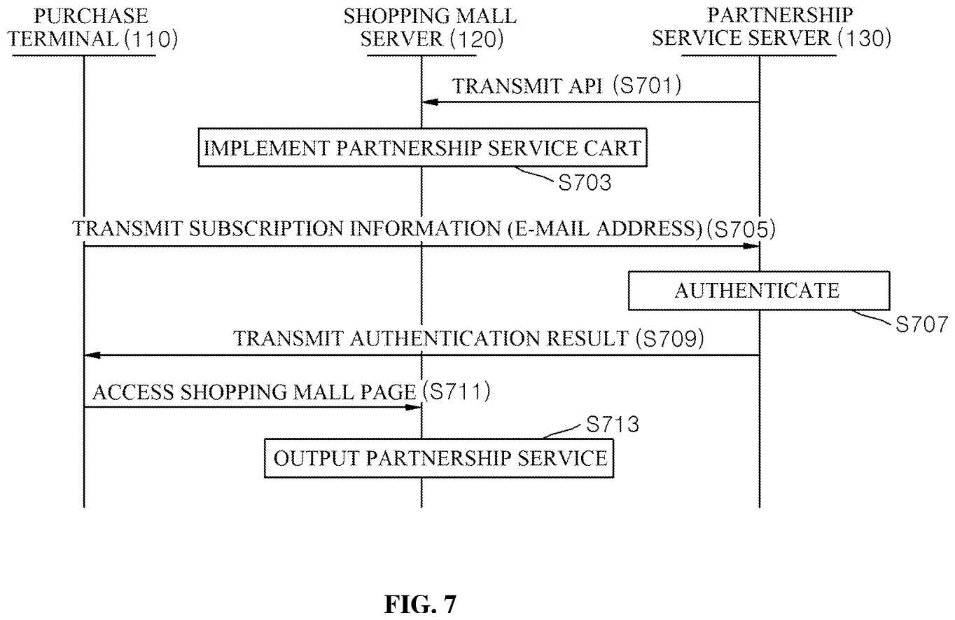

FIG. 7 is a flowchart illustrating subscription and authentication of electronic commerce service using a partnership service cart according to an embodiment.

FIG. 7 illustrates the operation of the purchaser terminal 110 subscribing to the electronic commerce service in the system for providing electronic commerce service using a partnership service cart.

The partnership service server 130 may transmit the API to the shopping mall server 120, and the shopping mall server 120 may acquire the API (operation S701). The shopping mall server 120 may implement the partnership service cart from the API (operation S703).

The purchaser terminal 110 may perform a subscription to use the electronic commerce service according to the embodiment. The purchaser terminal 110 may transmit the subscription information to the partnership service server 130 (operation S705). The subscription information may mainly include arbitrary personal identification information that is easy to obtain, such as an e-mail address, instead of non-arbitrary personal identification information that is difficult to obtain.

The partnership service server 130 may perform authentication through the subscription information including the e-mail address of the purchaser (operation S707). The partnership service server 130 may confirm whether the e-mail address actually exists and whether the e-mail address is duplicated, and may approve or reject the authentication.

The partnership service server 130 may transmit the authentication result to the purchaser terminal 110 (operation S709). In addition, the purchaser terminal 110 may access the shopping mall server 120 to use the online shopping mall (operation S711). The shopping mall server 120 may or may not output the partnership service server according to the authentication result (operation S713). In addition, the purchaser terminal 110 may or may not use the electronic commerce service using the partnership service cart according to the authentication result.

For example, when the authentication is approved, the shopping mall server 120 may generate and output a shopping mall page including a partnership service cart. The purchaser terminal 110 may receive the shopping mall page to which the partnership service cart is output, and the purchaser may purchase the product on the online shopping mall by putting the product into the partnership service cart. When the authentication is rejected, the shopping mall server 120 may generate and output the shopping mall page that does not include the partnership service cart. The purchaser terminal 110 may receive the shopping mall page without the partnership service cart, and the purchaser may purchase a product on the online shopping mall by putting the product into an individual cart provided by the shopping mall server 120 itself.

As described above, in the electronic commerce service according to the embodiment of the present invention, a purchaser may perform subscription only with simple subscription information (for example, non-arbitrary personal identification information). Conventionally, when a purchaser resides abroad and there is no procedure to verify identity, the purchaser may not use domestic online shopping malls through which it is difficult to verify identity. However, the purchaser may use the online shopping mall provided by the shopping mall server 120 by simply subscribing with non-arbitrary personal identification information through the partnership service server 130. In addition, when a purchaser uses a plurality of online shopping malls, it may not be necessary to individually subscribe to each online shopping mall. That is, the overseas purchaser may indirectly use the domestic online shopping mall through the partnership service server 130. In addition, the electronic commerce service according to the embodiment may provide the same effect by being equally applied to a purchaser who resides in Korea but whose identity is difficult to verify.

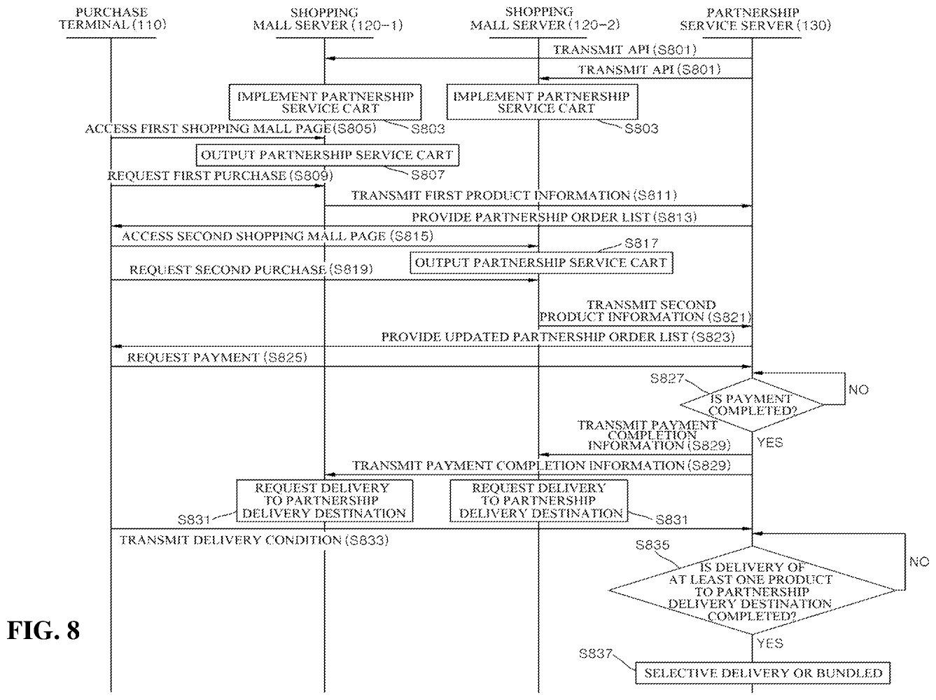

FIG. 8 is a flowchart illustrating an operation of a system for providing electronic commerce service using a partnership service cart according to an embodiment when a purchaser uses a plurality of online shopping malls.

Referring to FIG. 8, the operation of the system for providing electronic commerce service using a partnership service cart when a purchaser purchases products through a plurality of online shopping malls is illustrated.

When the purchaser purchases products through a plurality of online shopping malls, the system (see 100 in FIG. 1) may include the purchaser terminal 110, a first shopping mall server 120-1, a second shopping mall server 120-2, and the partnership service server 130. Here, the first shopping mall server 120-1 may operate a first online shopping mall, and the second shopping mall server 120-2 may operate a second online shopping mall, but the servers are not necessarily limited thereto.

The partnership service server 130 may transmit the API for the partnership service cart to each of the first shopping mall server 120-1 and the second shopping mall server 120-2 (operation S801). The API may be used to implement the partnership service cart in the first shopping mall server 120-1 and the second shopping mall server 120-2. Here, the partnership service cart implemented in the first shopping mall server 120-1 and the second shopping mall server 120-2 may have the same attribute.

Then, the first shopping mall server 120-1 may implement the partnership service cart from the API, and the second shopping mall server 120-2 may implement the partnership service cart from the API (operation S803). The first shopping mall server 120-1 or an administrator of the first shopping mall server 120-1 may link and combine the API with the API of the first online shopping mall, and the second shopping mall server 120-2 or an administrator of the second shopping mall server 120-2 may link and combine the API with the API of the second online shopping mall.

The purchaser terminal 110 may first access the first shopping mall page on the first online shopping mall and purchase a product (operation S805). The first shopping mall server 120-1 may confirm the access by the purchaser terminal 110, and determine whether the access by the purchaser terminal 110 is made from abroad. When the access by the purchaser terminal 110 is made from abroad, the first shopping mall server 120-1 may output the partnership service cart by including the partnership service cart in one or a plurality of first shopping mall pages of the first online shopping mall (operation S807).

The purchaser terminal 110 may select or specify a product and transmit a purchase request to the first shopping mall server 120-1 (operation S809). The purchase request transmitted to the first shopping mall server 120-1 may be referred to as a first purchase request. When the shopping mall server 120-1 receives the first purchase request, the shopping mall server 1 may transmit information (for example, a product name, price, quantity, supplier, etc.) on the first product included in the first purchase request to the partnership service server 130 (operation S811).

The partnership service server 130 may generate a partnership order list and transmit and provide the generated partnership order list to the purchaser terminal 110 (operation S813). The partnership order list may include one or a plurality of first products included in the first purchase request.

The purchaser terminal 110 may access the first shopping mall page on the first online shopping mall and purchase a product (operation S815). The second shopping mall server 120-2 may confirm the access by the purchaser terminal 110, and determine whether the access by the purchaser terminal 110 is made from abroad. When the access by the purchaser terminal 110 is made from abroad, the second shopping mall server 120-2 may output the partnership service cart by including the partnership service cart in one or a plurality of first shopping mall pages of the second online shopping mall (operation S817).

The purchaser terminal 110 may select or specify a product and transmit a second purchase request to the second shopping mall server 120-2 (operation S819). The purchase request transmitted to the second shopping mall server 120-2 may be referred to as a second purchase request. When the second shopping mall server 120-2 receives the second purchase request, the shopping mall server 2 may transmit information (for example, a product name, price, quantity, supplier, etc.) on the second product included in the second purchase request to the partnership service server 130 (operation S821).

The partnership service server 130 may update a partnership order list and provide the updated partnership order list to the purchaser terminal 110 (operation S823). The updated partnership order list may include not only one or a plurality of first products included in the first purchase request, but also one or a plurality of second products included in the second purchase request. Therefore, the purchaser may confirm products requested to be purchased from a plurality of online shopping malls through the partnership order list.

For the payment of the purchased product, the purchaser terminal 110 may transmit a payment request to the partnership service server 130 (operation S825). The partnership service server 130 may directly perform the payment or request the payment server (not illustrated) to process the payment.

The partnership service server 130 may confirm whether the payment is completed (operation S827). When the payment is not completed, the partnership service server 130 may continue to process the payment and wait until the payment is completed (NO in operation S827).

When the payment is completed, the partnership service server 130 may transmit payment completion information to the first shopping mall server 120-1 and the second shopping mall server 120-2 (YES in operation S827 and operation S829).

The first shopping mall server 120-1 and the second shopping mall server 120-2 may request delivery to a partnership delivery destination (operation S831). The first shopping mall server 120-1 may transmit a delivery request for at least one paid product among the products included in the first purchase request to a delivery server (not illustrated), or directly perform the delivery according to the delivery request. At the same time, the second shopping mall server 120-2 may transmit a delivery request for at least one paid product among the products included in the second purchase request to the delivery server (not illustrated), or directly perform the delivery according to the delivery request.

Meanwhile, the purchaser terminal 110 may transmit the delivery conditions to the partnership service server 130 (operation S833). Here, the delivery conditions may include the purchaser delivery destination and the delivery method, and may be for the requirements of the purchaser on how to deliver from the partnership delivery destination to the purchaser delivery destination.

The partnership service server 130 may confirm whether at least one of paid products is delivered to the partnership delivery destination (operation S835). When the delivery completion is not confirmed, the partnership service server 130 may wait until the delivery completion is confirmed (NO in operation S835).

When the delivery completion is confirmed, the partnership service server 130 may perform selective delivery or bundled delivery (YES in operation S835 and operation S837). Here, the selective delivery may be understood as some of a plurality of products that arrive at the partnership delivery destination being delivered first, and bundled delivery may be understood as some or all of a plurality of products that arrive at a partnership delivery destination being collected and these collected products being delivered at one time. The selective delivery and the bundled delivery may be determined by the purchaser, and the products may be delivered to the partnership service server 130 by being included in the delivery conditions.

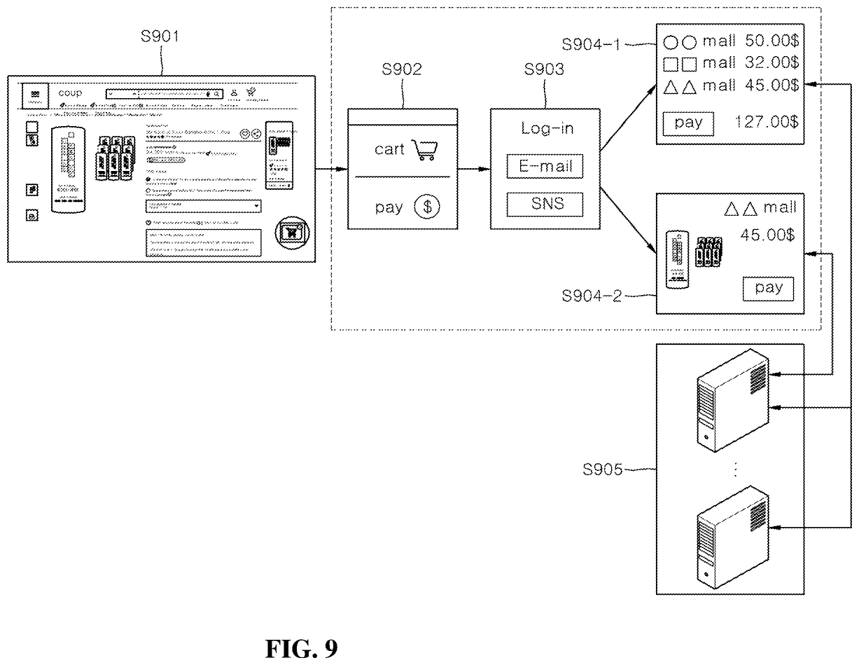

FIG. 9 is a diagram for describing a payment method in electronic commerce service according to an embodiment.

Referring to FIG. 9, the electronic commerce service according to the embodiment may provide a payment method including integrated payment or immediate payment. The partnership service server may provide services for integrated payment which allows a purchaser to pay for all products at once after selecting all the products, and immediate payment which allows a purchaser to pay for a product every time the purchaser selects one product. The partnership service server may perform an operation of selecting a payment method (operation S902), logging in by a purchaser (operation S903), and providing a partnership order list (operation S904) (see a dotted line in this drawing).

The purchaser may access a specific online shopping mall through the purchaser terminal 110 and purchase a specific product (operation S901). The shopping mall server may provide a shopping mall page including a partnership service cart as illustrated in this drawing to the purchaser terminal 110.

The purchaser terminal 110 may select a desired product and select a partnership service cart icon to purchase the product through the partnership service cart. The partnership service server may provide a service window capable of selecting the integrated payment or immediate payment to the purchaser terminal 110 before displaying the partnership order list (operation S902). When the purchaser selects “cart” through the purchaser terminal 110, the integrated payment may be performed, and when the purchaser selects “pay,” the immediate payment may be performed.

The partnership service server may provide a login window to the purchaser terminal 110 when the purchaser does not log in (operation S903). The purchaser may log in through an e-mail account or a social networking service account. This operation does not necessarily have to be started after the payment method selection operation, but may be started during another operation in some cases.

When the purchaser performs the integrated payment, the partnership service server may provide the first partnership order list to the purchaser terminal (operation S904-1). When there is a purchase request (purchase request through the integrated payment) of a purchaser, the partnership service server may generate and provide a first partnership order list including products purchased from a plurality of online shopping malls that the purchaser visits. For example, the first partnership order list may indicate a plurality of pieces of product information (a price, online shopping mall, quantity, total purchase amount, etc.) on products purchased from OO mall, □□ mall, and ΔΔ mall.

When the purchaser performs the immediate payment, the partnership service server may provide the second partnership order list to the purchaser terminal (operation S904-2). When there is a purchase request (purchase request through the immediate payment) of a purchaser, the partnership service server may generate and provide a second partnership order list including at least one product purchased from one online shopping mall that the purchaser currently visits. For example, the second partnership order list may indicate at least one piece of product information (a price, online shopping mall, quantity, total purchase amount, etc.) on products purchased from ΔΔ mall.

The purchaser terminal may generate a payment request and transmit the generated payment request to the partnership service server. The partnership service server may perform payment by itself or through a payment server. When the payment is completed, the partnership service server may generate payment completion information and transmit the generated payment completion information to the shopping mall server.

When the payment is completed, the partnership service server may request the shopping mall server to deliver the paid product to the partnership delivery destination (operation S905). When the integrated payment is made, the partnership service server may transmit a delivery request to a plurality of shopping malls corresponding to some or all of the products included in the partnership order list. When the immediate payment is made, the partnership service server may transmit a delivery request to one shopping mall corresponding to the product for which the immediate payment is made.

A “component,” “unit,” “block,” or “module” used in the present embodiment may be implemented as software, such as a task, a class, a subroutine, a process, an object, an execution thread, or a program, which is executed in a predetermined area on a memory, hardware such as a field programmable gate array (FPGA) or an application-specific integrated circuit (ASIC), or a combination of the software and hardware. The “components,” “units,” or the like may be included in a computer-readable storage medium, or some components may be dispersed and distributed in a plurality of computers. Also, one or more of the components may be implemented using one or more computing devices, or a part thereof. Such devices may include, for example, PCs, server computers, handheld or laptop devices, multiprocessor systems, microcontroller based systems, set top boxes, programmable electric home appliances, network PCs, minicomputers, mainframe computers, mobile phones, personal digital assistants (PDAs), gaming devices, printers, devices including set-top boxes, media centers, other devices, automotive-embedded or -attached computing devices, other mobile devices, distributed computing environments including any of the above systems or devices, and the like.

Meanwhile, the disclosed embodiments may be implemented in the form of a recording medium for storing a program and/or instructions executable by a computer. Instructions may be stored in the form of a program code, and when executed by a processor, may generate a program module to perform the operations of the disclosed embodiments. The recording medium may be implemented as a computer-readable recording medium. The computer-readable recording medium includes any type of recording medium in which instructions readable by the computer are stored. For example, there may be a read only memory (ROM), a random access memory (RAM), a magnetic tape, a magnetic disk, a flash memory, an optical data storage device, and the like.

As described above, according to the present embodiment, it is possible to increase accessibility to an online shopping mall by facilitating a purchase of an overseas purchaser through a partnership service cart implemented on a shopping mall page.

According to the present embodiment, it is possible to quickly perform an online purchase procedure and reduce a time difference between purchase and payment by performing subscription, purchase, payment, and delivery procedures automatically rather than manually by linking an API for realizing a partnership service cart with an online shopping mall service. According to the present embodiment, it is possible to be free from an influence of price fluctuations (for example, difference in an exchange rate) occurring between the purchase and payment by reducing a time difference between purchase and payment.

According to the present embodiment, it is possible to enable an overseas purchaser to purchase a product without complicated subscription and authentication of a domestic online shopping mall simply by subscribing through a partnership service server instead of a shopping mall server which is a subject operating a shopping mall page.

According to the present embodiment, it is possible to greatly reduce a delivery fee by not only putting products from different online shopping malls into one shopping cart and placing an integrated order for these products, but also bundling a plurality of products and performing integrated delivery of the bundled product.

According to the present embodiment, it is possible to integrate points or the like accumulated for each online shopping mall or use the points at once.

According to the present embodiment, it is possible to improve convenience by eliminating the need to input payment means, a payment method, payment information (an address, personal information, etc.), and the like to each online shopping mall every time payment is made.

The scope of protection of the present disclosure is not limited to the description and expression of the embodiments explicitly described above. In addition, it is stated once again that the protection scope of the present invention is not limited due to obvious changes or substitutions in the technical field to which the present invention pertains.

What is claimed is:

1. A method of providing electronic commerce service using a partnership service cart included in a shopping mall by a shopping mall server that is connected to a purchaser terminal through a wired/wireless network to provide a product cart, the method comprising:
acquiring an application programming interface (API) for realizing the partnership service cart on a shopping mall page;
outputting the partnership service cart realized by the API to the shopping mall page independently of the product cart;
receiving payment completion information in response to a payment request for a product put into the partnership service cart; and
transmitting a delivery request for the product included in the payment request upon receiving the payment completion information.

2. The method of claim 1, further comprising:
confirming access by the purchaser terminal to a shopping mall page; and
determining whether the access by the purchaser terminal is made from abroad,
wherein the outputting of the partnership service cart includes outputting the partnership service cart when the access by the purchaser terminal is made from abroad.

3. The method of claim 1, wherein the shopping mall page is implemented in a first language of a first country and provided to the purchaser terminal, and
the purchaser terminal accesses the shopping mall page from a country different from the first country.

4. The method of claim 1, wherein the shopping mall page is implemented in a first language of a first country and translated into a second language different from the first language and provided to the purchaser terminal, and
the purchaser terminal accesses the shopping mall page from a country different from the first country.

5. The method of claim 1, wherein the acquiring of the API includes acquiring the API for a plurality of online shopping malls,
the outputting of the partnership service cart includes separately outputting the partnership service cart to each of the shopping mall pages of the plurality of online shopping malls, and
the receiving of the payment completion information includes receiving payment completion information for a plurality of products that are selected from the shopping mall pages of the plurality of online shopping malls and put into the partnership service cart.

6. The method of claim 5, wherein the receiving of the payment completion information includes receiving payment completion information for some of the plurality of products, and
the transmitting of the delivery request includes transmitting a delivery request for some products included in the payment completion information.

7. The method of claim 1, wherein the outputting of the partnership service cart includes not outputting or deactivating the partnership service cart when a product is specified as an import ban item in a country where the access by the purchaser terminal is made, or when a product is specified as an export ban item in the country where the access by the purchaser terminal is made.

8. A shopping mall server for providing electronic commerce service using a partnership service cart included in a shopping mall, wherein the shopping mall server is connected to a purchaser terminal and a partnership service server through a wired/wireless network to provide the electronic commerce service, the shopping mall server comprising:
a communication unit configured to transmit or receive information or data through the wired/wireless network;
a control unit configured to acquire, from the partnership service cart, an application programming interface (API) for realizing the partnership service cart on a shopping mall page through the communication unit, receive payment completion information in response to a payment request for a product put into the partnership service cart, and transmit a delivery request for the product included in the payment request upon receiving the payment completion information; and
an output unit configured to output the partnership service cart realized by the API to the shopping mall page independently of the product cart.

9. A method of providing electronic commerce service using a partnership service server included in a shopping mall, wherein the partnership service server is connected to a purchaser terminal through a wired/wireless network to provide the electronic commerce service, the method comprising:
providing an application programming interface (API) for realizing the partnership service cart on a shopping mall page;
receiving, from the purchaser terminal, a payment request for a product through the partnership service cart output to the shopping mall page;
confirming whether the product included in the payment request is delivered to a partnership delivery destination specified by the partnership service server when payment is completed in response to the payment request;
receiving, from the purchaser terminal, a delivery condition for receiving the product included in the payment request, the delivery condition including a purchaser delivery destination and a delivery method; and
transmitting a delivery request for the product included in the payment request according to the purchaser delivery destination and the delivery method.

10. The method of claim 9, wherein the shopping mall page is implemented in a first language of a first country and provided to the purchaser terminal, and
the purchaser terminal accesses the shopping mall page from a country different from the first country.

11. The method of claim 9, wherein the shopping mall page is implemented in a first language of a first country and translated into a second language different from the first language and provided to the purchaser terminal, and
the purchaser terminal accesses the shopping mall page from a country different from the first country.

12. The method of claim 9, wherein the providing of the API includes providing the API for a plurality of online shopping malls,
the confirming of the delivery to the partnership delivery destination includes confirming whether at least one of a plurality of products included in the payment request is delivered to the partnership delivery destination, and
the transmitting of the delivery request includes transmitting a delivery request for at least one of the plurality of products when the delivery to the partnership delivery destination is completed.

13. The method of claim 12, wherein the delivery method includes selective delivery in which some of the plurality of products are delivered to the purchaser delivery destination and bundled delivery in which all of the plurality of products are delivered to the purchaser delivery destination at once.

14. The method of claim 9, further comprising:
receiving subscription information for use of the electronic commerce service from the purchaser terminal,
wherein the purchaser terminal performs a purchase request through the partnership service cart in the shopping mall page when authenticated through the subscription information from the partnership service server.

15. A partnership service server for providing electronic commerce service using a partnership service cart, wherein the partnership service server is connected to a purchaser terminal and a partnership service server through a wired/wireless network to provide the electronic commerce service, the partnership service server comprising:
a communication unit configured to transmit or receive information or data through the wired/wireless network;
an application programming interface (API) management unit configured to manage an API for realizing the partnership service cart on a shopping mall page;
a delivery confirmation unit configured to confirm whether a product included in a payment request is delivered to a partnership delivery destination specified by the partnership service server when payment is completed in response to the payment request for the product through the partnership service cart output to the shopping mall page;
a delivery request generation unit configured to generate a delivery request for the product included in the payment request according to the purchaser delivery destination and a delivery method; and
a control unit configured to receive, through the communication unit, a delivery condition for receiving the product included in the payment request from the purchaser terminal, the delivery condition including the purchaser delivery destination and the delivery method, and transmit the delivery request.
